(19) United States
(12) Patent Application Publication
(10) Pub. No.: US 2010/0223139 A1
(43) Pub. Date: Sep. 2, 2010

(54) COMMUNICATIONS SYSTEM PROVIDING PERSONALIZED MOBILE WIRELESS COMMUNICATIONS DEVICE NOTIFICATIONS AND RELATED METHODS

(75) Inventors: Sorel Bosan, Kitchener (CA); Janice Zima, Kitchener (CA); Michael K. Brown, Waterloo (CA)

Correspondence Address: Allen, Dyer, Doppelt, Milbrath & Gilchrist - RIM, 255 S. Orange Avenue, Suite 1401, Orlando, FL, 32801, US

(73) Assignee: Research In Motion Limited, Waterloo (CA)

(21) Appl. No.: 12/705,853

(22) Filed: Feb. 15, 2010

(30) Foreign Application Priority Data
Feb. 27, 2009 (EP) 09153991.6

(51) Int. Cl. G06Q 30/00; G06F 15/16

(52) U.S. Cl. 705/14.64; 709/206; 705/14.67; 726/11

(57) ABSTRACT

A communications system may include at least one mobile wireless communications device associated with a respective user, a network server within a protected computer network, and a notification server outside of the protected computer network for generating generic notifications. The network server may be for storing within the protected computer network personalizing information for the user of the at least one wireless communications device, receiving generic notifications from the notification server, and generating and sending to the at least one wireless communications device personalized notifications based upon the personalizing information and the generic notifications.

### TECHNICAL FIELD

The present disclosure relates to the field of communications systems, and, more particularly, to mobile wireless communications systems and related methods.

### BACKGROUND

Mobile communications systems continue to grow in popularity and have become an integral part of both personal and business communications. Mobile telephones allow users to place and receive voice calls most anywhere they travel. Moreover, as mobile telephone technology has increased, so too has the functionality of cellular devices and the different types of devices available to users. For example, many mobile devices now incorporate personal digital assistant (PDA) features such as calendars, address books, task lists, etc. Moreover, such multi-function devices may also allow users to wirelessly send and receive electronic mail (email) messages and access the Internet via a cellular network and/or a wireless local area network (WLAN), for example.

As a result, users continue to spend more time using their mobile devices during the course of a day, as opposed to early cellular phones that were used only for phones calls. This has resulted in a significant interest from the advertising community in targeting advertisements to mobile devices.

One exemplary system for directing targeted advertising or transmitting information to end users, using wireless or mobile media, including cellular media, is disclosed in U.S. Patent Pub. No. 2007/0055565.

The system interconnects (a) advertisers or sponsors, (b) wireless device users (“system users”), and (c) wireless telecommunications companies (“telecoms”), via (d) an intermediary or “hub entity.” The hub entity maintains and controls computer operated software and data bases to direct specific advertising or information to targeted system users, collects subscription fees and distributes advertising fees, and determines the effectiveness of various advertising or information transmitted to specific system users.

Despite the advantages of such approaches, further functionality may be desirable for providing notifications, such as advertisements, to mobile wireless communications device users.

### BRIEF DESCRIPTION OF THE DRAWINGS

FIG. 1 is a schematic block diagram of a communications system in accordance with one exemplary embodiment.

FIG. 2 is a flow diagram illustrating exemplary communications method embodiments.

FIG. 3 is a schematic block diagram of an alternative embodiment of the system of FIG. 1.

FIG. 4 is a flow diagram illustrating alternative exemplary communications method aspects of the method of FIG. 2.

FIG. 5 is a schematic block diagram of an alternative embodiment of the communications system of FIG. 1.

FIG. 6 is a schematic block diagram illustrating exemplary components of a mobile wireless communications device that may be used for determining vehicle traffic rate or density, or passing pedestrian traffic density, in accordance with exemplary embodiments.

### DETAILED DESCRIPTION

The present description is made with reference to the accompanying drawings, in which various embodiments are shown. However, many different embodiments may be used, and thus the description should not be construed as limited to the embodiments set forth herein. Rather, these embodiments are provided so that this disclosure will be thorough and complete. Like numbers refer to like elements throughout, and prime notation is used to indicate similar elements or steps in alternative embodiments.

The present application advantageously addresses the technical problem of how to allow notifications, such as advertisements, to be personalized for a known demographic of users, while at the same time providing privacy to users by not disseminating their personal or private information beyond the trusted confines of a protected computing environment. Considered alternatively, the present application addresses the technical problem of how to provide personalized notifications (e.g., advertisements) to mobile wireless communications device users when the notification provider is not permitted access to personal information of the device users.

These technical problems are addressed by a communications system which may include at least one mobile wireless communications device associated with a respective user, a network server within a protected computer network, and a notification server (e.g., an advertising server) outside of the protected computer network for generating generic notifications (e.g., advertisements). More particularly, the network server may be configured to store for storing within the protected computer network personalizing information for the user of the at least one wireless communications device, receive generic notifications from the notification server, and generate and send to the at least one wireless communications device personalized notifications based upon the personalizing information and the generic notifications.

More particularly, the personalizing information may include a user name, and the network server may generate the personalized notifications by adding the user name to the generic notifications. By way of example, the generic notifications may have at least one target field therein, and the network server may generate the completed notifications by filling the personalizing information in the at least one target field. Additionally, the generic notifications may have at least one key word therein, and the network server may generate the personalized notifications by replacing the at least one key word with the personalizing information.

The network server may further store notification preferences within the protected computer network, and filter the generic notifications based upon the notification preferences. The notification preferences may include user notification preferences, network notification preferences, or both, for example. The network server may further advantageously generate a report of personalized notifications sent to the at least one wireless communications device and send the report to the notification server.

The communications system may also include a computer firewall module connected between the network server and the wide area network to provide the protected computing network. Additionally, the at least one wireless communications device may include a plurality thereof each associated with a respective different user. Furthermore, the at least one wireless communications device may also be for sending and receiving electronic mail (email) messages via the wide area network, and the network server may further reconcile email messages between an email inbox on the at least one wireless communications device and an email inbox within the protected computer network. The network server may communicate with the notification server via a wide area network, such as the Internet, for example.

A related communications method may include storing personalizing information for a user of the at least one wireless communications device within a protected computer network, and receiving generic notifications from a notification server outside of the protected computer network. The method may further include generating and sending to the at least one wireless communications device personalized notifications based upon the personalizing information and the generic notifications.

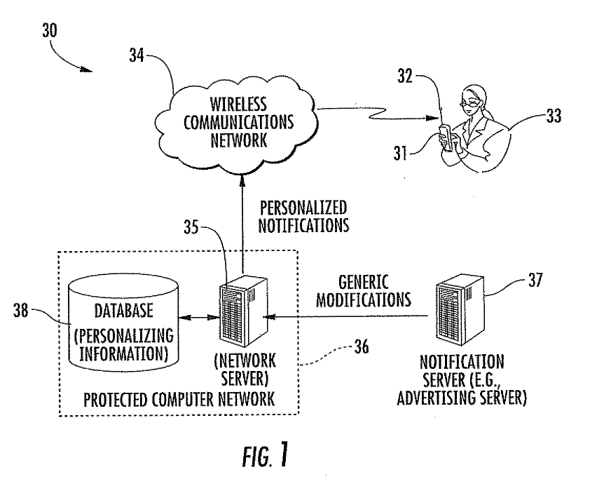

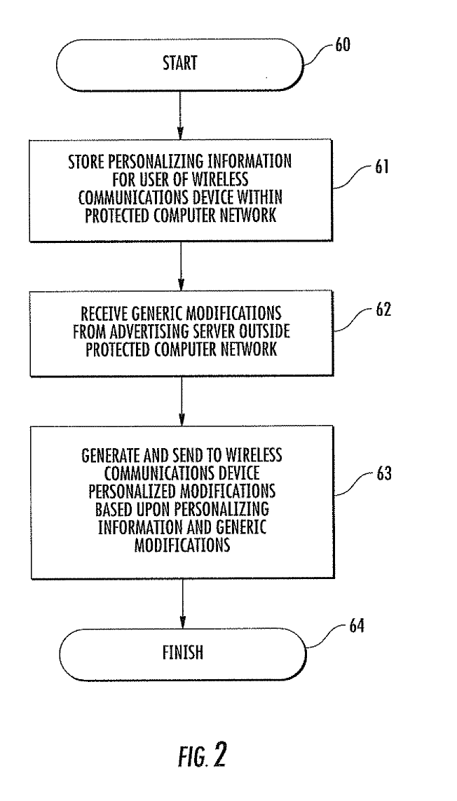

Referring initially to FIGS. 1 and 2, a communications system 30 and associated communications method aspects are first described. The system 30 illustratively includes one or more mobile wireless communications devices 31 and associated antenna 32. A respective user 33 is associated with the device 31. Moreover, the system 30 further illustratively includes a wireless communications network 34, a network server 35 within a protected computer network 36, and a notification server 37, which may comprise an advertising server, outside of the protected computer network. However, it should be noted that in different embodiments notifications other than advertisements may be used (e.g., news notifications, etc.)

By way of example, the device 31 and wireless communications network 34 may operate in accordance with a cellular, wireless LAN (e.g., 802.11x, Bluetooth, etc.), WiMAX, satellite, etc., communications format, as will be appreciated by those skilled in the art. In some embodiments, more than one such wireless communications format may be used in the same device (e.g., cellular, wireless LAN, and Bluetooth). Moreover, the device 31 also illustratively includes one or more associated antennas 32. Various types of mobile wireless communications devices 31 may be used, such as mobile phones, PDAs, laptop computers, wireless-enabled cameras, wireless-enabled media players, etc., for example. Moreover, the wireless communications network 34 (or portions thereof) may also reside within the protected computer network 36, such as in the case of a wireless LAN, WiMAX, etc., network.

Beginning at Block 60, the network server 35 may advantageously store within the protected computer network (e.g., in a database 38) personalizing information for the user 33 of the device 31, at Block 61. By way of example, the personalizing information may include a name of the user, as well as other applicable information such as title (e.g., Mr., Mrs., Ms., etc.), occupation, degrees, residence information, age or age group, race or ethnicity, gender, income or income bracket, geographic location, political affiliation, religion, marital status, number of children, etc. Moreover, additional information may be stored in the database 38 as well, such as advertising preference information. More particularly, the advertising preference information may include preferences of the user (e.g., the types of products or services, or both, the user is interested (or not interested) in), such as restaurants, songs, recording artists, actors, movies, TV shows, books, authors, etc. In some embodiments, network advertising preferences may additionally (or instead) be stored as well, such as what types of advertisements may or may not (or both) be communicated to user devices 31, as will be discussed further below.

By way of example, the network server 35 and database 38 may be implemented using a combination of hardware (e.g., microprocessor, memory, etc.) and software components or modules. Moreover, the various functions of the network server 36 and database 38 may be implemented in a single server or database, or implemented using multiple different servers and databases, as will also be appreciated by those skilled in the art.

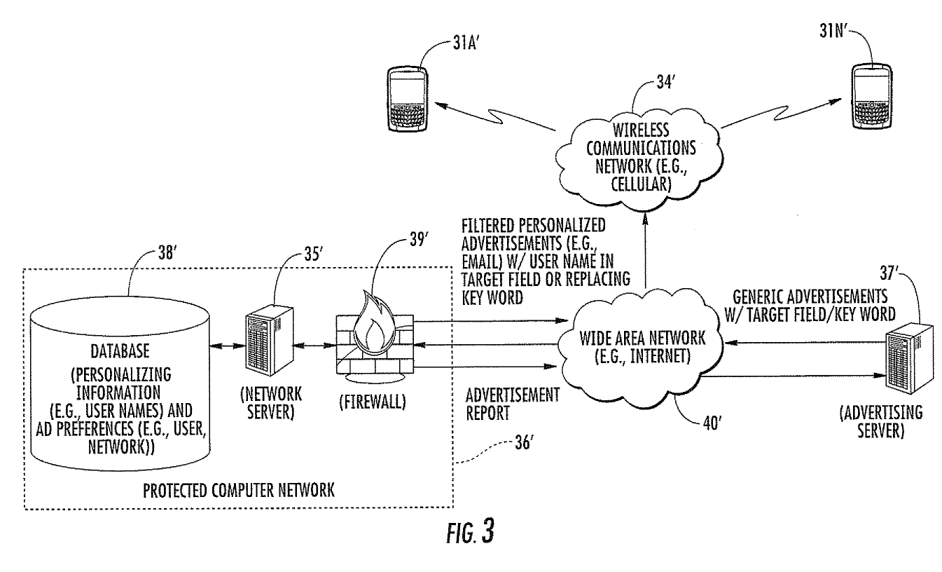

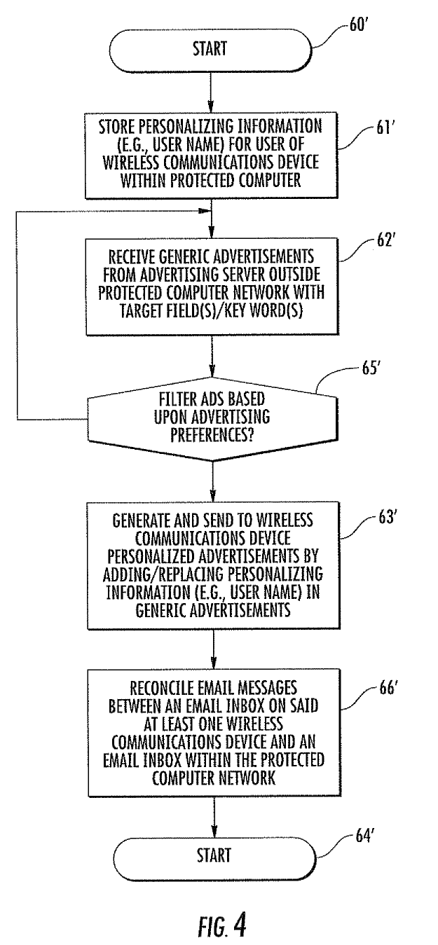

The advertising server 37 is for generating generic advertisements to be received by the network server 35, at Block 62. More particularly, the generic advertisements may be of a general nature and not specifically addressed to, targeted to, tailored to, or otherwise personalized for any particular user. However, these advertisements may advantageously be generated with a “placeholder” to allow for later personalization, such as a target field(s) or key word(s) that can later be filled in with or replaced by the personalizing information to generate personalized advertisement for sending to the user(s) 33, at Block 63, thus concluding the method illustrated method in FIG. 3 (Block 64).

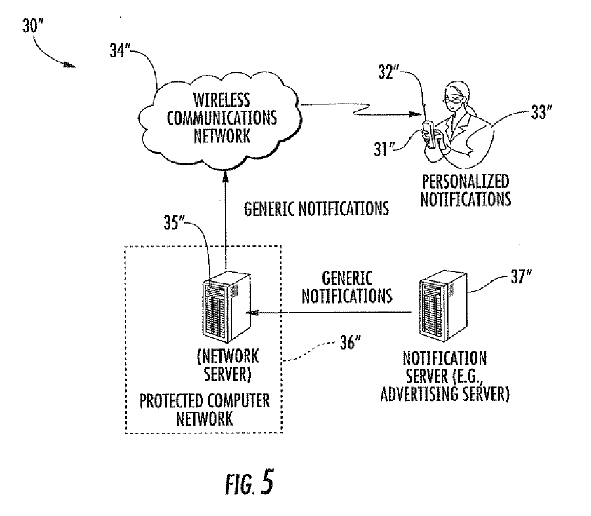

Taking the example of a written text advertisement, such as in the form of an electronic mail (email) message, a target field may be a tag (e.g., an extensible markup language (XML) tag) or other identifier within the email message that identifies where the user's name, title, etc., is to be inserted. As such, upon receiving a generic advertisement from the advertising server 37, the network server 35 searches and replaces the target field(s) therein with the corresponding personalizing information of the user(s) 33 to which a personalized advertisement is to be sent (Block 63′, FIG. 4). In the example of a key word, the generic advertisement email message may include a generic greeting of “Dear Customer,” which phrase the network server 35 may replace with “Dear Jason,” for a user named Jason, etc. Moreover, the advertisements need not be text only, and may include other items (e.g., images) in addition to, or instead of text, as will be appreciated by those skilled in the art. Combinations of these two approaches may be used in some embodiments, as well as other suitable approaches for personalizing a generic advertisement with personalizing information, as will also be appreciated by those skilled in the art. Another example in that with the personalizing information, a photograph or graphic may be tailored to the user 33, such as in an advertisement for clothing showing a model of the same gender, age group, size, etc.

An advantage of storing the personalizing information in a database 38 within the protected computer network 36 is that this information may be kept private and inaccessible to the advertising server. That is, this approach advantageously addresses the technical problem of how to allow advertisers to achieve personalized advertisements to a known demographic of users, while at the same time providing privacy to users by not disseminating their personal or private information beyond the trusted confines of the protected computing environment 36.

Referring additionally to FIG. 7, in some embodiments, the system 30 may advantageously be implemented in accordance with the Open Mobile Alliance (OMA) Mobile Advertising Requirements (see OMA-RD-Mobile-Advertising-V1_{—}0-20080805-C, 2008 Open Mobile Alliance Ltd., Candidate Version 1.0, available at http://www.openmobilealliance.org/Technical/release_program/mobad_v1_{—}0.aspx). In accordance with the OMA MobAd specification, the notification server 37′″ may be implemented as an advertiser server or Ad Network server, content provider server, etc., that will provide generic notifications to the network server 35′″, as will be appreciated by those skilled in the art. Moreover, in the context of DMA MobAd specification, the network server 35′″ may be implemented as a MobAd Ad Server, as will also be appreciated by those skilled in the art. In this regard, the MobAd Ad Server 35′″ may access personalized information of users from a series of data repositories 38′″ including, for example, one or more of an extensible markup language (XML) document management (XDM) server 70′″, presence server 71′″, location server 72′″, etc. The MobAd Ad Server 35′″ may then personalize the generic notification while maintaining the user's privacy, and send the personalized notification to the device 31′″.

Still within the context of the OMA MobAd specification, generic notifications received by the MobAd Ad Server 35′″ may be passed to a service provider application (i.e., SP App) 73′″ without being personalized. The SP App 73′″ is an application running in the same protected network as the MobAd Ad Server 35′″ and may have its own personalized information about the user. In that case the generic notifications are personalized by the SP App 73′″ in the protected computer network 36′″ before being sent to the user. Generally speaking, the network (or MobAd Ad) server 35′″ may be the main receiver of generic notifications, and may dispatch such generic notifications to various specific application servers running in the same protected computer network 36′″, which will personalize the generic notifications before sending them to the device 31′″.

In the example of FIG. 3, the system 30′ illustratively includes a firewall module 39′, which again may be implemented using a combination of hardware and software components, that defines the protected computer network 36′, as will be appreciated by those skilled in the art. That is, the network server 35′ and database 38′ are illustratively insulated or protected from external networks, such as wide area networks 40′ like the Internet, through which the network server 35′ and the advertising server 37′ may communicate. As a result, since users know that their personal or private information is being maintained within a secure environment and not disclosed to advertisers, they may be more readily willing to participate in an advertising program where advertisements are delivered to their mobile devices 31 based upon this information. Other suitable approaches for protecting or securing user data so that it is inaccessible by the advertising server 37′ or other outside sources in addition to, or instead or, the firewall module 39′ may also be used in some embodiments, as will be appreciated by those skilled in the art.

As noted above, the network server 35′ may further store advertising preferences within the protected computer network 36′ (e.g., within the database 38′). These advertising preferences may then be used to filter the generic advertisements, so that undesirable or impermissible advertisements are not sent to the devices 31a′-31n′. If the advertising preferences are user advertising preferences, that is, preferences set by or specific to individual users, then the network server 35′ may advantageously filter or exclude advertisements of a type that the user does not wish to receive. For example, a user who is dieting may not want to receive advertisements for food, desserts, or restaurants. As such, key word or category based filters may be set so that any advertisements provided to the network server 35′ that meet the defined criteria will be filtered out and not converted to personal advertisements for, nor sent to, the respective user device 31′.

In addition to, or instead of, user advertising preferences, network advertising preferences may also be stored that apply to all or different subsets of network users. By way of example, if the protected computer network 36′ is implemented as a company or corporate computer network, then network advertising preferences may be stored to set corporate-wide advertising policies for filtering the generic advertisements, at Block 65′. For example, a given corporation may exclude any advertisements from being sent to company employees from a competing corporation.

In a corporate implementation, the corporation may establish an account with a third party advertising service to provide advertisements for distribution to corporate users via the advertising server 37′. This may be done in exchange for monetary consideration to the corporation, for example. Another potential implementation is that the protected computer network 36′ is an Internet service provider (ISP), and clients are provided Internet access for a reduced (or no) fee in exchange for agreeing to receive the advertisements on their registered mobile devices.

One exemplary approach for implementing the systems 30 or 30′ in a corporate setting is through an enterprise server, such as the BlackBerry® Enterprise Server (BES) from the present Assignee Research In Motion, Ltd. In particular, a BES generally comprises a wireless platform for wireless email, Personal Information Management (PIM), instant messaging (IM) and other corporate data. A network server 35′, such as a BES, may advantageously reconcile email messages between respective email inbox (or other email boxes) on the wireless communications device 31a′-31n′ and corresponding email inboxes within the protected computer network 36′, at Block 66′, as will be appreciated by those skilled in the art.

The foregoing filtering or personalized advertisement features, or both, may advantageously be incorporated as part of such a corporate BBS implementation, as will be appreciated by those skilled in the art. Moreover, a similar home BES implementation (or other suitable implementation) may also be used for a home network implementation. In such an application, personalized advertisements may be sent to multiple members in a family, with user advertising preferences or network advertising preferences, or both (or no filtering preferences).

A server such as a BES may or may not locally store information such as GPS data, browser history, browser bookmarks, or WiFi network data, for example. In an exemplary implementation, the BES includes MDS and other servers including Mobile Voice Services which locally maintain such information. Such a server may be able to tie into other servers/databases as appropriate to extract the information as needed. Both single and distributed server scenarios may be used. That is, in some implementations the information may be included as part of a single server box, and other implementations may include distributed servers to which the BES has access, as will be appreciated by those skilled in the art.

In accordance with another advantageous feature, the network server 35′ may generate a report of personalized advertisements sent to the mobile wireless communications devices 31a′-31n′, and send the report to the advertising server 37′ via the wide area network 40′. This may be particularly appropriate for accounting purposes to determine what monies, etc., are owed if filtering is used and not all of the advertisements being sent to the network server 35′ are in fact being sent to the devices 31a′-31n′.

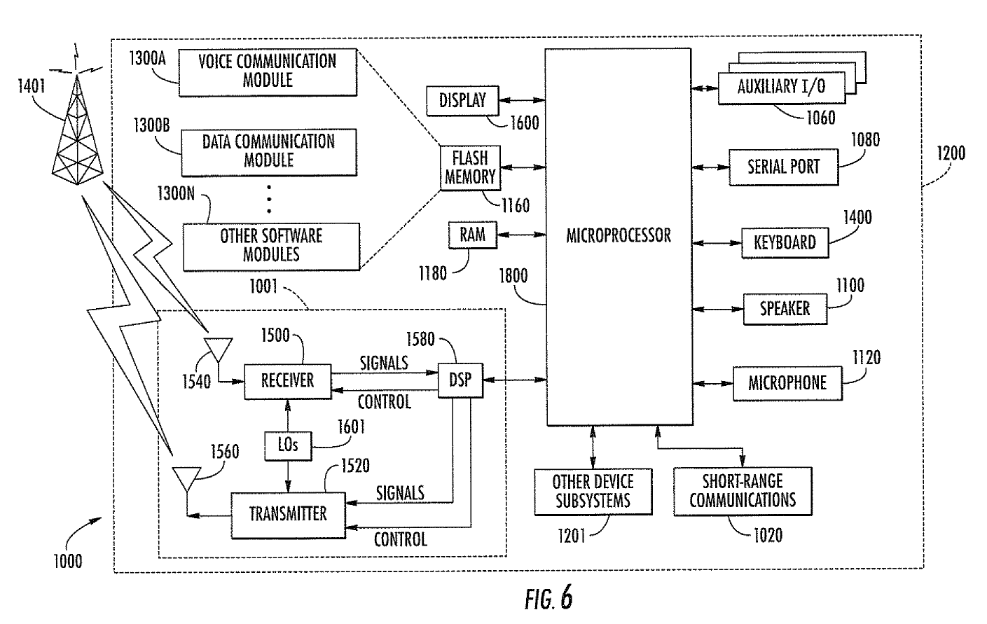

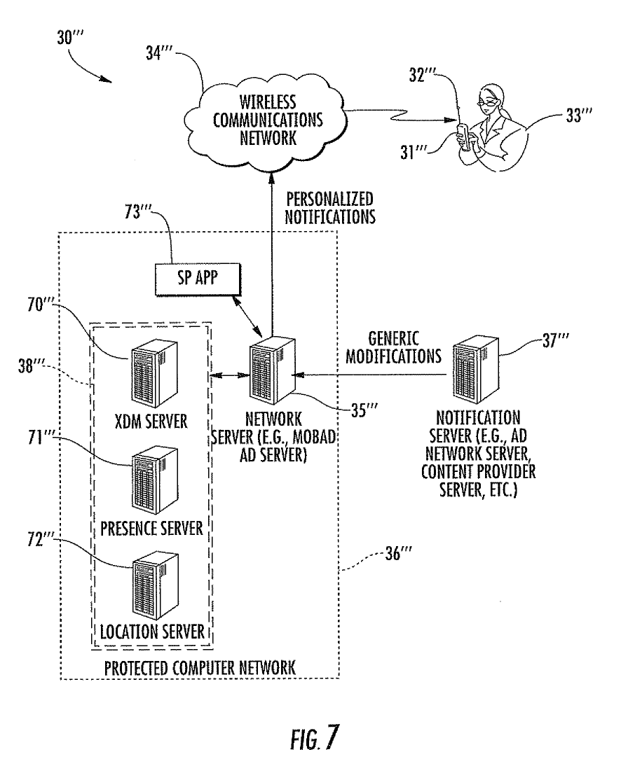

Turning now additionally to FIG. 5, in another exemplary embodiment the notification personalization functions of the network server 35 described above may instead (or in cooperation therewith) be performed by the wireless communications device 31″. More particularly, the device 31″ may include one or more memories (e.g., a FLASH memory 1160, RAM memory 1180, etc., as seen in FIG. 6) for storing the personalizing information, as well as a processor (e.g., the microprocessor 1800 shown in FIG. 6). The processor may therefore advantageously generate personalized notifications based upon generic notifications received through the network server 35″ (or directly from the notification server 37″ in some embodiments) based upon the stored personalizing information and the received generic notifications in the same manner discussed above, as will be appreciated by those skilled in the art.

In the context of the OMA MobAd Specification, the Ad Engine, which is the advertising engine running on the device 31″, will receive the generic notification and personalize them according to the above-desired method. Alternatively, the Ad Engine may receive the generic notifications and pass them to an Ad App (i.e., an ad aware application). The Ad App will then personalize the notifications according to their respective particular context. For instance, a name field may be replaced by the user name known by that particular Ad App. In some cases this may be a surname, avatar name, networking nickname, etc.

Exemplary components of a mobile wireless communications device 1000 that may be used in accordance with the system 30 are further described in the example below with reference to FIG. 6. The device 1000 illustratively includes a housing 1200, a keypad 1400 and an output device 1600. The output device shown is a display 1600, which may comprise a full graphic LCD. In some embodiments, display 1600 may comprise a touch-sensitive input and output device. Other types of output devices may alternatively be utilized. A processing device 1800 is contained within the housing 1200 and is coupled between the keypad 1400 and the display 1600. The processing device 1800 controls the operation of the display 1600, as well as the overall operation of the mobile device 1000, in response to actuation of keys on the keypad 1400 by the user. In some embodiments, keypad 1400 may comprise a physical keypad or a virtual keypad (e.g., using a touch-sensitive interface) or both.

The housing 1200 may be elongated vertically, or may take on other sizes and shapes (including clamshell housing structures). The keypad 1400 may include a mode selection key, or other hardware or software for switching between text entry and telephony entry.

In addition to the processing device 1800, other parts of the mobile device 1000 are shown schematically in FIG. 6. These include a communications subsystem 1001; a short-range communications subsystem 1020; the keypad 1400 and the display 1600, along with other input/output devices 1060, 1080, 1100 and 1120; as well as memory devices 1160, 1180 and various other device subsystems 1201. The mobile device 1000 may comprise a two-way RF communications device having voice and data communications capabilities. In addition, the mobile device 1000 may have the capability to communicate with other computer systems via the Internet.

Operating system software executed by the processing device 1800 may be stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications 1300A-1300N on the device 1000. A predetermined set of applications that control basic device operations, such as data and voice communications 1300A and 1300B, may be installed on the device 1000 during manufacture. In addition, a personal information manager (PIM) application may be installed during manufacture. The PIM may be capable of organizing and managing data items, such as e-mail, calendar events, voice mails, appointments, and task items. The PIM application may also be capable of sending and receiving data items via a wireless network 1401. The PIM data items may be seamlessly integrated, synchronized and updated via the wireless network 1401 with the device user's corresponding data items stored or associated with a host computer system.

Communication functions, including data and voice communications, are performed through the communications subsystem 1001, and possibly through the short-range communications subsystem. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOs) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TAC™ or General Packet Radio Service (GPRS) mobile data communications networks, and also designed to operate with any of a variety of voice communications networks, such as AMPS, TDMA, CDMA, WCDMA, PCS, GSM, EDGE, etc. Other types of data and voice networks, both separate and integrated, may also be utilized with the mobile device 1000. The mobile device 1000 may also be compliant with other communications standards such as 3GSM, 3G, UMTS, 4G, etc.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore utilizes a subscriber identity module, commonly referred to as a SIM card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device user may also compose data items, such as e-mail messages, using the keypad 1400 and/or some other auxiliary I/O device 1060, such as a touchpad, a rocker switch, a thumb-wheel, track ball, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem may include an infrared device and associated circuits and components, or a Bluetooth™ communications module to provide for communication with similarly-enabled systems and devices.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

1-15. (canceled)

16. A communications system comprising:
at least one mobile wireless communications device associated with a respective user;
a network server within a protected computer network; and
a notification server outside of the protected computer network for generating generic notifications;
wherein said network server is configured to:
store within the protected computer network personalizing information for the user of said at least one wireless communications device,
receive generic notifications from said notification server, and
generate and sending to said at least one wireless communications device personalized notifications based upon the personalizing information and the generic notifications.

17. The communications system of claim 16,
wherein the personalizing information comprises a user name, and
wherein said network server generates the personalized notifications by adding the user name to the generic notifications.

18. The communications system of claim 16,
wherein the generic notifications have at least one target field therein, and
wherein said network server generates the personalized notifications by filling the personalizing information in the at least one target field.

19. The communications system of claim 16,
wherein the generic notifications have at least one key word therein; and
wherein said network server generates the personalized notifications by replacing the at least one key word with the personalizing information.

20. The communications system of claim 16,
wherein said network server is configured to store notification preferences within the protected computer network, and
wherein said network server is configured to filter the generic notifications based upon the notification preferences.

21. The communications system of claim 20 wherein the notification preferences comprise user notification preferences.

22. The communications system of claim 20 wherein the notification preferences comprise network notification preferences.

23. The communications system of claim 20,
wherein said network server further generates a report of personalized notifications sent to said at least one wireless communications device; and
wherein said network server is further configured to send the report to said notification server.

24. The communications system of claim 16 further comprising a computer firewall module connected between the network server and the wide area network to provide the protected computing network.

25. The communications system of claim 16,
wherein said notification server comprises an advertising server; and
wherein the notifications comprise advertisements.

26. The communications system of claim 16,
wherein said at least one wireless communications device is also configured to send and receive electronic mail (email) messages; and
wherein said network server is further configured to reconcile email messages between an email inbox on said at least one wireless communications device and an email inbox within the protected computer network.

27. The communications system of claim 16 wherein said network server communicates with said advertising server via a wide area network.

28. A communications system comprising:
at least one mobile wireless communications device associated with a respective user; and
a network server within a protected computer network is configured to
store within the protected computer network personalizing information for the user of said at least one wireless communications device,
receive generic notifications from a notification server outside of the protected computer network, and
generate and sending to said at least one wireless communications device personalized notifications based upon the personalizing information and the generic notifications.

29. The communications system of claim 28,
wherein the personalizing information comprises a user name; and
wherein said network server generates the personalized notifications by adding the user name to the generic notifications.

30. The communications system of claim 28,
wherein the generic notifications have at least one target field therein; and
wherein said network server generates the personalized notifications by filling the personalizing information in the at least one target field.

31. The communications system of claim 28,
wherein the generic notifications have at least one key word therein; and
wherein said network server is configured to generate the personalized notifications by replacing the at least one key word with the personalizing information.

32. The communications system of claim 28,
wherein said network server is configured to store notification preferences within the protected computer network; and
wherein said network server further filters the notifications based upon the notification preferences.

33. The communications system of claim 28 wherein the generic notifications comprise advertisements.

34. A communications method comprising:
storing personalizing information for a user of at least one wireless communications device within a protected computer network;
receiving generic notifications from a notification server outside of the protected computer network; and
generating and sending to the at least one wireless communications device personalized notifications based upon the personalizing information and the generic notifications.

35. The method of claim 34,
wherein the personalizing information comprises a user name; and
wherein generating comprises generating the personalized notifications by adding the user name to the generic notifications.

36. The method of claim 34,
wherein the generic notifications have at least one target field therein; and
wherein generating comprises generating the personalized notifications by filling the personalizing information in the at least one target field.

37. The method of claim 34,
wherein the generic notifications have at least one key word therein; and
wherein generating comprises is configured to generate the personalized notifications by replacing the at least one key word with the personalizing information.

38. The method of claim 34 further comprising filtering the notification templates based upon advertising preferences.

39. The method of claim 34 wherein the generic notifications comprise advertisements.
